(19) United States
(12) Patent Application Publication
(10) Pub. No.: US 2003/0046866 A1
(43) Pub. Date: Mar. 13, 2003

(54) Planter having multiple cells

(76) Inventor: Marquette Mendes, Leroy, NY (US)

Correspondence Address: Jaeckle Fleischmann & Mugel, LLP, 39 State Street, Suite 200, Rochester, NY, 14614-1310, US

(21) Appl. No.: 10/241,983

(22) Filed: Sep. 12, 2002

Related U.S. Application Data
(60) Provisional application No. 60/318,780, filed on Sep. 12, 2001.

(51) Int. Cl. A01G 9/02

(52) U.S. Cl. 47/87

(57) ABSTRACT

A planter having a plurality of cells, each for receiving one or more plants such that an overall vegetative representation of a predetermined pattern is formed. The cells may be occupiable directly by the root balls of plants or by plants in pots, or combinations thereof. The cells may be rectangular or other shape. The cells may be arranged in a regular grid array or in any other spatial relationship. The predetermined pattern may be determined by the pattern of the cells, or it may be imposed on a non-patterned arrangement of cells, for example a regular grid, through selection and placement of individual plants according to a predetermined planting template. The template may be a program design wherein the spatial location of each plant is specified; or it may be an actual physical element, for example, a paper design superimposable on the planter through which the selected plants are inserted to form the vegetative design in the planter. Plants to be accommodated may be of any type or size, including annuals and perennials.

### CROSS REFERENCE TO RELATED APPLICATIONS

This application claims the benefit of U.S. Provisional Patent Application Serial No. 60/318,780, filed Sep. 12, 2001.

### TECHNICAL FIELD

The present invention relates to devices for receiving live, growing plants; more particularly, to devices for receiving and displaying a plurality of live, growing plants; and most particularly, to a planter having a plurality of planting cells, each cell for receiving one or more plants such that an overall vegetative representation of a predetermined pattern is formed.

### BACKGROUND OF THE INVENTION

Planters having a plurality of cells for receiving a plurality of plants are well known. For example, U.S. Pat. No. 5,953,859, “Rechargeable Live-planter Assembly and Method of Use Thereof” issued Sep. 21, 1999, is drawn to a planter comprising a receptacle body which is embedable in the earth and having at least one cavity formed therein for receiving a removable storage tray, allowing easy removal and replacement of stored plants at gravesites, etc. U.S. Pat. No. 4,118,892, “Connectable Nursery Box Structures Having Compartmentalizing Grids” issued Oct. 10, 1978, is drawn to a molded synthetic resin nursery box comprising a grid member dividing the box into individual compartments. Adjacent boxes may be connected to form a grid array of boxes. The planted boxes may be installed on a horizontal surface whereby the grid members are strong enough to withstand the weight of a person walking thereupon to prevent trampling and plant damage.

Prior art multiple-cell planters are not provided with the capability or objective of providing a pleasing arrangement of plants in a programmable, predetermined, decorative pattern of plants.

Therefore, what is needed in the art is an improved multiple-cell planter for receiving a plurality of live, growing plants wherein the plants may be spatially arranged to form at least one predetermined decorative vegetative pattern.

Furthermore, what is needed in the art is a planter wherein any of a plurality of patterns may be formed.

Moreover, what is needed in the art is a planter wherein a pattern may be formed either by the specific spatial arrangement of cells or by the imposition of a planting template upon a non-specific arrangement of cells.

### SUMMARY OF THE INVENTION

The present invention provides a planter and a method and apparatus for providing a pleasing arrangement of plants.

The invention comprises, in one form thereof, a planter comprising a plurality of cells to form a design. Furthermore, the cells are arranged for receiving one or more plants such that an overall vegetative representation of a predetermined pattern is formed. The pattern may be ornamental or informational; representational or abstract. The different plants in different cells may be of the same species or of different species. The cells may be occupiable directly by the root balls of plants or by plants in pots, or combinations thereof.

An advantage of the present invention is that the layout of cells can provide a pleasing arrangement of plants in a predetermined, decorative pattern.

Another advantage of the present invention is that the cells may be occupiable by either the root balls of plants or by plants in pots.

Yet another advantage of the present invention is that the upper surface of the planter may be parallel to the ground or inclined at any desired angle thereto.

Other advantages of the present invention will be obvious to one skilled in the art and/or appear hereinafter.

### BRIEF DESCRIPTION OF THE DRAWINGS

These and other features and advantages of the invention will be more fully understood and appreciated from the following description of certain exemplary embodiments of the invention taken together with the accompanying drawings, in which:

FIG. 1 is isometric view of generally rectangular shaped planter in accordance with the invention;

FIG.2 is a side view of FIG. 1 as viewed in the direction of A;

FIG. 3 is a top view of FIG. 1 as viewed in the direction of B;

FIG. 4 is an alternate embodiment of a side view as viewed in the direction of A;

FIG. 5 is an alternate embodiment of a top view as viewed in the direction of B;

FIG. 6 is a third embodiment of a top view as viewed in the direction of B;

FIG. 7 is an alternate embodiment of a top view; and

FIGS. 8a and 8b are isometric views of an alternate embodiment of the planter.

### DETAILED DESCRIPTION OF INVENTION

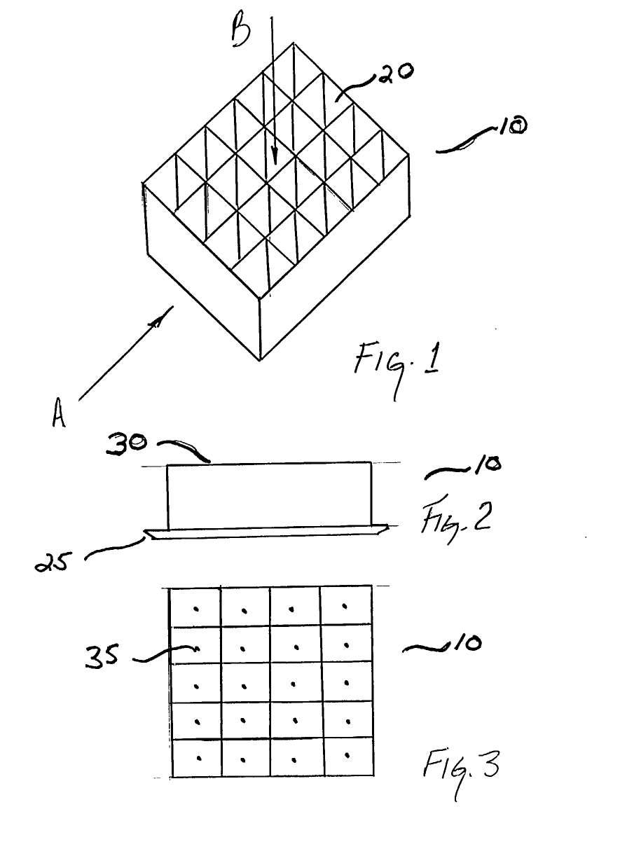

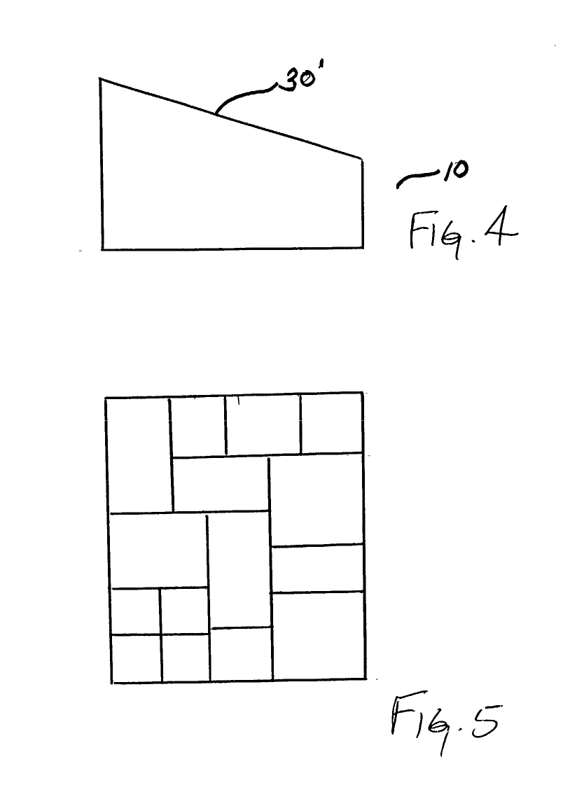

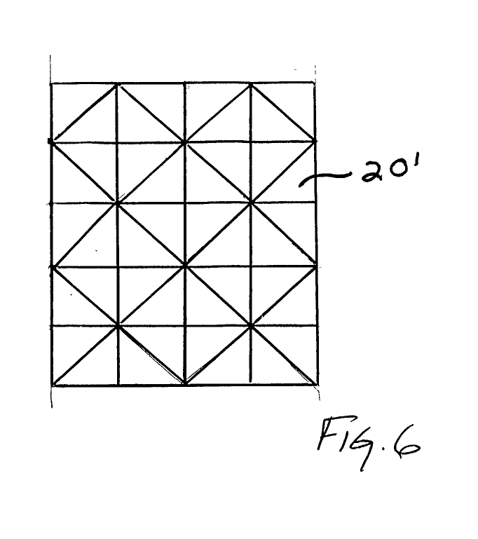

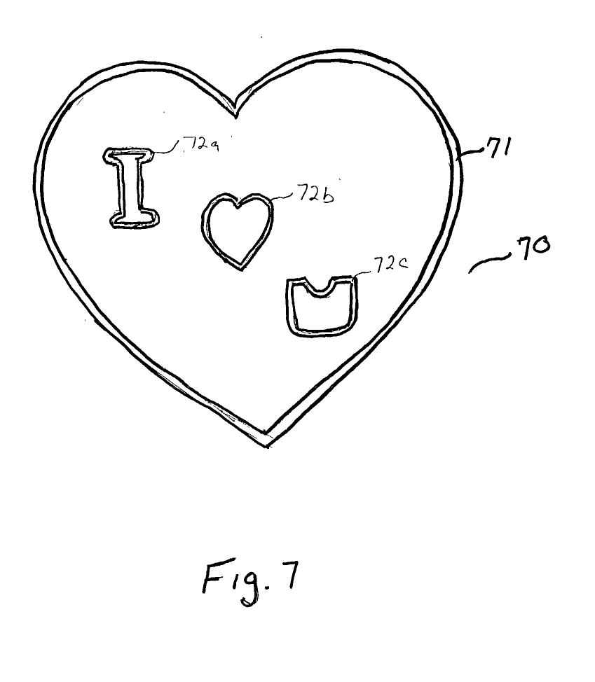

Referring now to the drawings, and particularly to FIGS. 1-3, there is shown a planter 10 according to one embodiment of the present invention. In the embodiment shown, the planter 10 is a rectangular shaped planter. The planter further comprises a plurality of cells 20, wherein the cells are typically occupied by plants, however some cells 20 may be occupiable by items other than plants, for example, statuary or other artwork. As shown in FIGS. 1-3 cells 20 may be rectangular, however other embodiments providing different shapes are possible. FIGS. 5 and 6 illustrate some of the possible configurations in which the cells can be arranged. While the upper surface 30 of the planter 10 shown in FIGS. 1-3 is parallel to the bottom surface of the planter, FIG. 4 shows a side view of an embodiment of the present invention where the upper surface 30′ of the planter is inclined at an angle.

The planter of the present invention may be integrally formed by a suitable molded material, such as plastic, however any other material, suitable for holding plants may be used. Additionally, it is also possible for the planter to be constructed from wood.

An additional embodiment of the planter of the present invention has a drainage means associated with each cell to allow water to drain from the planter. The drainage means can be in the form of one or more weep holes 25, allowing the cell to hold the soil and root ball of the plant, while allowing the passage of water. Additional embodiments of the present invention include a drip pan 35 below the cells for receiving the water that drains from the weep holes.

While rectangular 20 and triangular cells 20′ are illustrated, different cells may have different shapes, such as round, oval or any other shape, and various sizes. FIG.7 displays a planter 70 with a decoratively shaped outer wall 71, as well as a number of decoratively shaped cells 72a, 72b, and 72c. Additionally, it is possible to have cells within other cells, as well as cells that do not border other cells.

The cells may be arranged in a regular grid array or in any other spatial relationship. The predetermined pattern may be determined by the pattern of the cells, or it may be imposed on a non-patterned arrangement of cells, for example a regular grid, through selection and placement of individual plants according to a plotting means, such as predetermined planting template.

The plotting means such as a template for the cells of the planter may be a program design wherein the spatial location of each plant is specified; or it may be an actual physical element, for example, a paper design superimposable on the planter through which the selected plants are inserted to form the vegetative design in the planter. Also a direction sheet assigning particular plant varieties to designated cells of the planter may be used. Additionally, a series of planters can be combined to form a design, a name, or a logo. The layout of the plurality of planters can be preplanned, with the plants inserted in the cells prior to setting the individual planters together to form the display.

The various embodiments of the planter of the present invention may be embedable in the ground or supported above the ground by legs or other supportive means. The upper surface of the planter may be generally parallel to the ground or may be inclined at any desired angle thereto. The variety of plants to be accommodated may be of any type or size, including annuals and perennials.

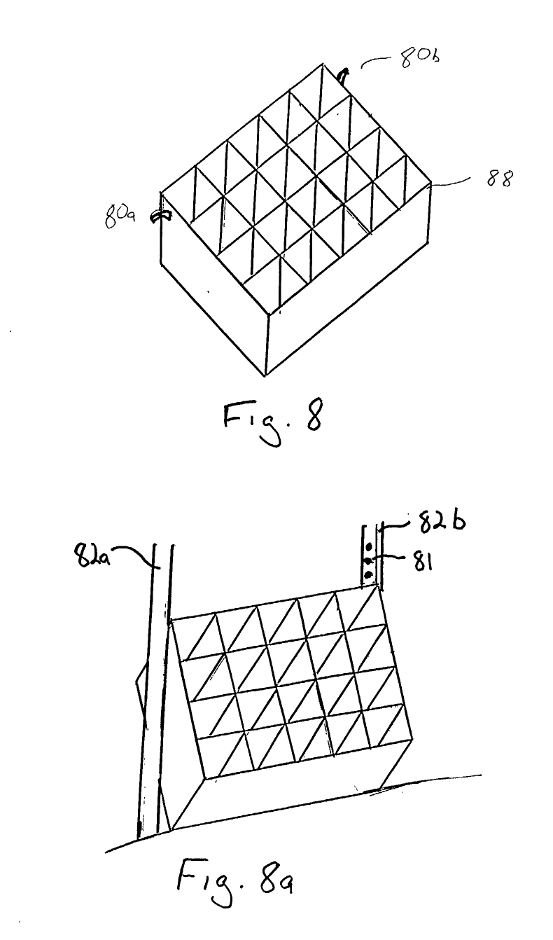

The planter of the present invention may be mounted on an angle, for display purposes FIGS. 8 and 8a, with the addition of mounting hooks 80a and 80b, attached to the housing 87 of the planter 88 and a pair of mounting rods 82a and 82b. The mounting hooks 80a and 80b, and mounting rods 82a and 82b, can be comprised of any suitable material. The mounting hooks 80a and 80b will mate with any of a plurality of mounting holes 81 on the pair of mounting rods 82a and 82b. The mounting rods 82a and 82b are set in the ground on opposing sides of the planter 88. The angle of the planter display can be increased or decreased by mating the mounting hooks 80a and 80b in upper or lower mounting holes 81 of the mounting rods 82a and 82b as desired. While the embodiment displayed uses two mounting hooks and two mounting rods, any embodiment utilizing one or more hooks will be possible.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A plant display system comprising:
a housing having an outer wall, a bottom, and a plurality of cells, wherein said cells are separated from each other by partition walls; and
a plant plotting means that designates each cell of said plurality of cells and indicates a type of plant to be placed in each designated cell of a plurality of designated cells that form a pre-determined pattern.

2. The plant system of claim 1 wherein said housing is comprised of an integral molded plastic piece.

3. The plant system of claim 1 wherein said housing further comprises a drainage means associated with each of said cells for allowing water to drain.

4. The plant system of claim 3 further comprising a drip pan for receiving water passing from a drainage means of said planter.

5. The plant system of claim 1 further comprising one or more mounting hooks for mounting to one or more mounting rods for varying the display angle of the planter as desired.

6. The plant system of claim 1 further comprising an upper surface, wherein said upper surface is parallel to said bottom of said planter.

7. The plant system of claim 1 further comprising an upper surface, wherein said upper surface is on an incline relative to said bottom of said planter.

8. The plant system of claim 1 wherein said outer wall of said housing is a predetermined decorative shape.

9. The plant system of claim 8 wherein said predetermined decorative shape is a heart shape.

10. A method of forming a predetermined decorative vegetative pattern for a planter having a plurality of cells, wherein said cells are separated from each other by partition walls comprising the steps of:
applying a plant plotting means to said planter, wherein said plant plotting means designates a pattern to place the plants in said plurality of cells;
planting each vegetative variety in the associated cell as designated by said plant plotting means; and
forming a decorative vegetative pattern.

11. The method of forming a predetermined decorative vegetative pattern as in claim 10 wherein said cells of said planter are prearranged in a decorative pattern.

12. The method of forming a predetermined decorative vegetative pattern as in claim 10 further comprising the steps of:
creating a template of a desired vegetative pattern;
superimposing said template of said cells of said planter; and
planting the associated vegetative variety in the associated cell as defined by the template.

13. The method of forming a predetermined decorative vegetative pattern as in claim 12 wherein said cells of said planter form a rectangular grid.

14. The method of forming a predetermined decorative vegetative pattern as in claim 10 wherein at least one cell is occupied by a non-vegetative entity.

15. The method of forming a predetermined decorative vegetative pattern as in claim 10 wherein said cells comprise a drainage means for allowing water to drain.

16. The method of forming a predetermined decorative vegetative pattern as in claim 10 further comprising a plurality of planters, wherein said plurality of planters are joined together to form a larger decorative vegetative design.

17. A planter assembly comprising:
a housing having an outer wall, a bottom, and a plurality of cells, wherein said plurality cells are separated from each other by partition walls; and
said plurality of cells are arranged in a predetermined decorative pattern.

18. A planter assembly as in claim 17 wherein at least one of said plurality of cells contains soil and live vegetation.

19. A planter assembly as in claim 17 wherein at least one of said plurality of cells contains a potted plant.

20. A planter assembly as in claim 17 wherein at least one of said plurality of cells contains a non-vegetative entity.
